(19) United States
(12) Patent Application Publication
(10) Pub. No.: US 2024/0222654 A1
(43) Pub. Date: Jul. 4, 2024

(54) BIPOLAR PLATE FOR A FUEL CELL SYSTEM AND PRODUCTION THEREOF

(71) Applicant: Robert Bosch GmbH, Stuttgart (DE)

(72) Inventor: Kai Weeber, Heimsheim (DE)

(21) Appl. No.: 18/555,040

(22) PCT Filed: Feb. 22, 2022
(86) PCT No.: PCT/EP2022/054307

§ 371 Date: Oct. 12, 2023

(30) Foreign Application Priority Data
Apr. 13, 2021 (DE) 10 2021 203 628.7

(51) Int. Cl. H01M 8/0258; B29C 48/00; B29C 59/04; B29L 31/34; H01M 8/0247; H01M 8/0267

(52) U.S. Cl. CPC H01M 8/0258; H01M 8/0247; H01M 8/0267; B29C 48/002; B29C 59/04; B29L 2031/3468

(57) ABSTRACT

The presented invention relates to a bipolar plate (100) for a fuel cell system (700), wherein the bipolar plate (100) is made of a material comprising plastic. The bipolar plate (100) comprises a top shell (200) and a bottom shell (300) with respectively a top side and a bottom side that is opposite the top side, wherein flow channels for guiding a first operating medium through the bipolar plate (100) are formed on the top side of the top shell (200).

### BACKGROUND OF THE INVENTION

Bipolar plates for fuel cell applications transport operating media for the operation of a fuel cell system, e.g. hydrogen, air, and coolant, and must conduct electrical power generated by the fuel cell system.

Bipolar plates are generally made of a metal and are produced in an embossing process such that a structure embossed on a front side is mandatory to provide a structure of the back side. Accordingly, a media supply of, e.g., an air guide on a top side and a coolant guide on a bottom side are dependent on each other, such that the air guide cannot be optimized independently of the coolant guide and a compromise must always be found between a performance of the air guide and a performance of the coolant guide.

This compromise has a significant impact on temperature distribution and vapor saturation in the fuel cell system and, thereby, also on aging of fuel cells, as well as on cold start behavior and specific shutdown strategies of the fuel cell system.

In general, a distinction is made between two basic bipolar plate constructions. On the one hand, what is referred to as a “cross-flow design” exists, in which a straight connection line between inlet channels and outlet channels for a respective operating medium intersects with a straight connection line between inlet channels and outlet channels for another operating medium. On the other hand, what is referred to as a “counter-flow design” exists, in which a connection line between inlet channels and outlet channels runs directly in a straight line or by the shortest possible path.

The cross-flow design provides good utilization of an active area of the bipolar plate and little waste in the production of a corresponding membrane unit, but has a sub-optimal cooling performance due to an inhomogeneous temperature distribution, which can lead to premature aging of a corresponding cell.

The counter-flow design provides advantageous cooling through a homogeneous temperature distribution, but has a very complex distribution structure and thereby a high amount waste when producing a corresponding membrane unit, as well as a sub-optimal surface area for the active surface.

### SUMMARY OF THE INVENTION

Presented in the context of the invention presented are a bipolar plate, a production method for a bipolar plate, and a fuel cell system. Further features and details of the invention will emerge from the respective dependent claims, the description, and the drawings. In this context, the features and details described in connection with the bipolar plate according to the invention also apply in connection with the production method according to the invention and the fuel cell system according to the invention, and respectively vice versa, so that with respect to the disclosure, mutual reference to the individual aspects of the invention is or can always be made.

The invention presented serves in particular to enable efficient operation of a fuel cell system with a long service life.

Presented according to a first aspect of the invention presented is a bipolar plate for a fuel cell system. The bipolar plate is made of a material comprising plastic. The bipolar plate comprises a top shell and a bottom shell each having a top side and a bottom side opposite the top side, whereby first flow channels are formed on the top side of the top shell for guiding a first operating medium through the bipolar plate, whereby second flow channels are formed between the bottom side of the top shell and the top side of the bottom shell for guiding a second operating medium through the bipolar plate, whereby the third flow channels are formed on the bottom side of the bottom shell for guiding a third operating medium through the bipolar plate, whereby the first flow channels connect inlet channels and outlet channels for the first operating medium in a straight line, whereby the second flow channels run in a straight line between inlet channels and outlet channels for the second operating medium, whereby the inlet channels and outlet channels for the second operating medium run orthogonally to the second flow channels, whereby the third flow channels run in a straight line between inlet channels and outlet channels for the third operating medium, and whereby the inlet channels and outlet channels for the third operating medium run orthogonally to the third flow channels.

In the context of the invention presented, the term “operating medium” is understood to mean a substance supplied to a fuel cell system or circulating in the fuel cell system, e.g. fuel, air, or coolant.

In the context of the invention presented, the term “plastic” is understood to mean a synthetically produced material, in particular polypropylene or polyethylene sulfide.

The bipolar plate presented is based on the principle of being formed from two half shells, a top shell and a bottom shell made of a material comprising plastic. In particular, the top shell and the bottom shell are made entirely of plastic.

Both the top shell and the bottom shell each comprise flow channels on their top sides and their bottom sides that are different from one another or are designed independently of one another. In other words, a production process for flow channels on a respective top side has no influence on the flow channel design on a corresponding bottom side.

The independent design of flow channels on the top side and the bottom side of respective half-shells is made possible by the material provided according to the invention comprising plastic. The material comprising plastic can be machined or embossed, milled, deformed or lasered such that only a corresponding structure is generated on the machined surface and not, as unavoidable with thin metals due to stresses in the metal, embossing a top side, which leads to deformation of the bottom side.

Due to the properties of the material comprising plastic provided according to the invention, the bipolar plate presented represents a hybrid of counter-flow and cross-flow, in that first flow channels are provided on an upper side or an air side, respectively, of the upper shell, which connect inlet channels and outlet channels for a first operating medium, in particular air, in a straight line and accordingly have a counter-flow characteristic.

Between the top shell and the bottom shell of the bipolar plate presented, second flow channels are formed through the bottom side of the top shell and the top side of the bottom shell. The structures on the bottom side of the top shell differ from the first flow channels on the top side of the top shell in such a way that they run in regions orthogonally to the first flow channels.

The second flow channels seal the coolant, so a coolant can be guided through the second flow channels. For this purpose, the top shell is connected to the bottom shell in a coolant-tight manner by employing, for example, an adhesive or a welding method for connection.

The structures extending orthogonally to the first flow channels and structures running in a straight line between the structures on the bottom side of the top shell, in combination with corresponding structures on the top side of the bottom shell, provide inlet channels and outlet channels as well as second flow channels for a second operating medium, in particular a coolant. In other words, the second operating medium is guided in a first direction into the inlet channel(s) and is then guided through second flow channels arranged orthogonally to the inlet channels to the outlet channel(s), which in turn are run orthogonally to the second flow channels, i.e. parallel to the inlet channels. Accordingly, the structures provided for the second operating medium by the top shell and the bottom shell show exhibit a cross-flow characteristic and a counter-flow characteristic.

On the bottom side of the bottom shell, third flow channels are formed in a straight line between inlet channels and outlet channels for the third operating medium. in this case, the inlet channels and outlet channels for the third operating medium extend orthogonally to the third flow channels. Furthermore, the inlet channels and outlet channels for the second operating medium are interchanged in their positions with the inlet channels and outlet channels for the third operating medium, such that a straight connection line between the inlet channels for the second operating medium and the outlet channels for the second operating medium intersects with a straight connection line between the inlet channels for the third operating medium and the outlet channels for the third operating medium. Accordingly, the bipolar plate for the second and third operating medium has a cross-flow characteristic, whereby the second and third flow channels extend in a straight line and accordingly also exhibit a counter-flow characteristic. Accordingly, the bipolar plate presented forms a hybrid of cross-flow and counter-flow characteristics.

It can be provided that the plastic provided according to the invention is an electrically and thermally conductive thermoplastic.

Thermoplastics are particularly advantageous for producing half-shells that comprise independent structures on their top sides and their bottom sides. For example, by means of an embossing tool, a first pattern can be designed on the top side of a thermoplastic, and a second pattern can be designed at the same timepoint or at another timepoint.

In this case, processing the top side does not result in any changes on the bottom side, and vice versa.

It can be further provided that flow channels of the top shell and the bottom shell, which are formed on the respective top side, differ at least in regions in their cross-section and/or their orientation and/or their number of flow channels formed on the respective bottom side.

Different geometries, i.e., different cross-sections, orientations, and/or number of respective flow channels formed on a top side and a bottom side of a respective half-shell, enable different flow characteristics to be achieved on the top side and the bottom side. In particular, a counter-flow characteristic can be achieved on a top side and a cross-flow characteristic can be achieved on a bottom side.

It can be further provided that flow channels of the top shell and the bottom shell, which are formed on the top side, are formed at least in regions in a mirror-symmetrical manner to a mirror axis extending between the top shell and the bottom shell.

Particularly effective thermal exchange between fluids flowing on the top surface and the bottom surface can be achieved by means of, at least in regions, mirror-symmetrical flow channels on the top surface and the bottom surface of a half-shell of the bipolar plate presented. In particular, mirror-symmetrical flow channels create an overlay area that in which a first fluid flows from one side and with a second fluid from a second side, such that a direct heat transfer can take place from the first fluid to the second fluid. Such symmetry is excluded by an embossing process of a metal sheet in which flow channels are present on a top side as a positive shape and flow channels are present on a bottom side as a negative shape.

In a second aspect, the invention presented relates to a production method for a possible embodiment of the cell stack presented. The production method comprises, for a top shell and a bottom shell respectively, an extruding step for extruding a material comprising plastic, a first generation step for generating a first pattern of flow channels on a first side of the material, a second generation step for generating a second pattern of flow channels on a second side of the material opposite to the first side, whereby the first pattern and the second pattern are generated independently of each other. Furthermore, the production method comprises a connecting step for connecting the top shell to the bottom shell for producing the bipolar plate.

The phrase “Independent generation of two patterns” in the context of the invention presented means a process in which the generation of a first pattern has no influence on the generation of the second pattern, so that geometries of the first pattern and the second pattern can be selected independently of each other. In particular, an independent generation of the second pattern can comprise a first work step for the generation of a first pattern and a second work step for the generation of a second pattern. The first work step and the second work step can in this case be performed separately and/or using different tools.

It can therefore be provided that the first pattern can be generated using a first embossing tool, and the second pattern can be generated using a second embossing tool.

By using different embossing tools, such as a double roller, through which a material is embossed simultaneously on its top side and bottom side, two different patterns corresponding to the respective embossing tools can be embossed.

To connect the top shell to the bottom shell, they can, e.g., be glued or welded together.

Furthermore, it can be provided that the first pattern is generated at a first timepoint, and the second pattern is generated at a second timepoint different from the first timepoint.

By means of chronologically separate generation steps for different patterns on different sides of a material to form the bipolar plate presented, e.g. a single tool, e.g. a laser, can be used to generate different patterns.

Furthermore, complex structures, e.g., flow channels extending in a first direction and then inlet channels and outlet channels extending orthogonally to the first direction, can be generated particularly easily and efficiently using multiple tools, e.g. multiple punches, during different generation steps.

In a third aspect, the invention presented relates to a fuel cell system having a plurality of bipolar plates according to the present invention.

The fuel cell system presented is particularly thermally stable due to the bipolar plates and exhibits only minimal signs of aging over time.

### BRIEF DESCRIPTION OF THE DRAWINGS

Further advantages, features, and details of the invention will emerge from the following description, in which exemplary embodiments of the invention are described in detail with reference to the drawings. In this context, the features specified in the claims and in the description can each be essential to the invention, individually or in any combination.

Shown are:

FIG. 1 a schematic diagram of the bipolar plate according to the invention in a top plan view,

FIG. 2 a top plan view of a top side of a bottom shell of the bipolar plate in FIG. 1,

FIG. 3 a top view of a bottom side of the bottom shell in FIG. 2,

FIG. 4 one possible embodiment of a top shell of the bipolar plate presented in a side view,

FIG. 5 a temperature profile of a coolant guided through the bipolar plate in FIG. 1,

FIG. 6 a possible embodiment of the method according to the invention,

FIG. 7 a possible embodiment of the fuel cell system according to the invention,

### DETAILED DESCRIPTION

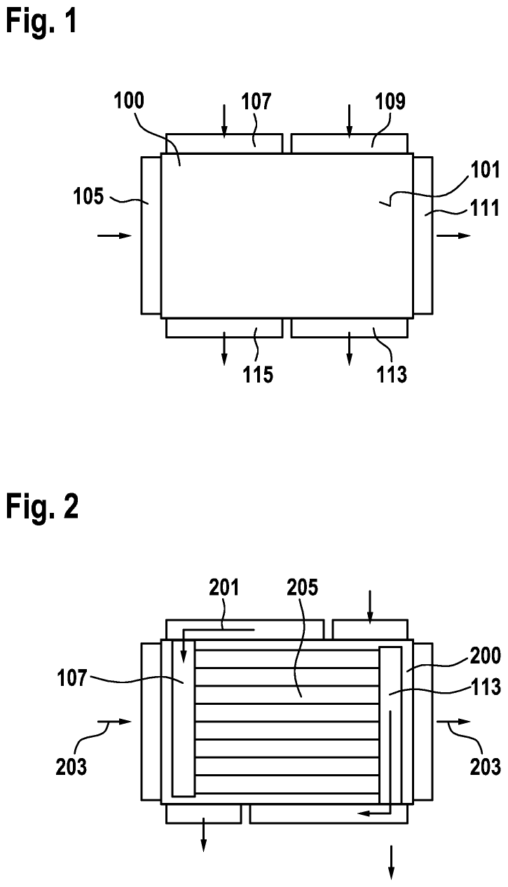

FIG. 1 shows a bipolar plate 100 having an active area 101. A first operating medium, in this case air, flows through the bipolar plate 100 via a first inlet channel 105, a second inlet channel 107 with a second operating medium, in this case coolant, and a third inlet channel 109 with a third operating medium, in this case hydrogen. Air is discharged via a first outlet channel 111, coolant via a second outlet channel 113, and hydrogen or exhaust gas via a third outlet channel 115.

While air is guided in a straight line from the first inlet channel 105 to the first outlet channel 111, i.e. with a counter-flow characteristic, the second inlet channel 107, the second outlet channel 113, the third inlet channel 109 and the third outlet channel 115 are arranged crosswise, i.e., with a cross-flow characteristic.

FIG. 2 shows a bottom side of a top shell 200, in this case a cathode half-shell of the bipolar plate 100. The bottom of the top shell 200 together with a top side of a bottom shell forms structures for guiding the coolant. As indicated by arrow 201, the second inlet channel 107 extends orthogonally to a direction of flow of air on a top side of the top shell 200, as indicated by arrows 203. Similarly, the second outlet channel 113 extends orthogonally to the direction of flow of the air.

Second flow channels 205 for the coolant extend parallel to the direction of flow of the air and correspondingly orthogonally to the second inlet channel 107 and the second outlet channel 113. Correspondingly, coolant guided through the second inlet channel 107 flows with a z-shaped flow characteristic from the second inlet channel 107 via the second flow channels 205 to the second outlet channel 113 and finally out of the bipolar plate 100.

Due to the second flow channels 205 extending parallel to the direction of flow of the air, there is an effective transition of thermal energy between the air and coolant flowing in the second flow channels 205.

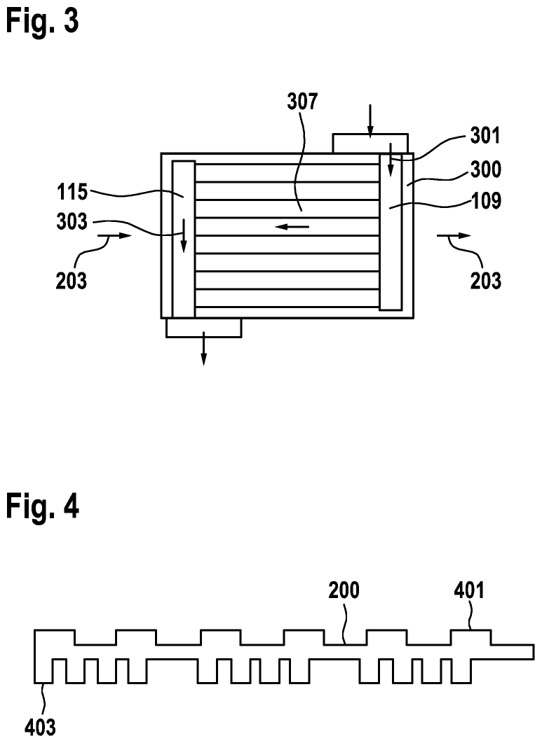

FIG. 3 shows a bottom shell 300, in this case an anode half-shell of the bipolar plate 100. As indicated by the arrow 301, the third inlet channel 109 extends orthogonally to a direction of flow of air. Similarly, as indicated by arrow 303, the third outlet channel 115 extends orthogonally to the direction of flow of the air.

Third flow channels 307 extend parallel to the direction of flow of air and coolant and correspondingly orthogonally to the third inlet channel 109 and the third outlet channel 115. Accordingly, a third operating medium, in this case hydrogen, guided through the third inlet channel 109 flows with a z-shaped flow characteristic from the third inlet channel 109 via the third flow channels 307 to the third outlet channel 115 and finally out of the bipolar plate 100.

Due to the second flow channels 205 extending parallel to the direction of flow of the air and the coolant, there is an effective transition of thermal energy between the coolant and hydrogen flowing in the third flow channels 207.

FIG. 4 shows the top shell 200 in a side view. It is in this case readily apparent that a surface structure of a top side 401 of the top shell 200 differs greatly from a surface structure of a bottom side 403 of the top shell 200, in particular, such that it does not fit as positively and negatively to each other, as is typical for patterns embossed in a metal sheet.

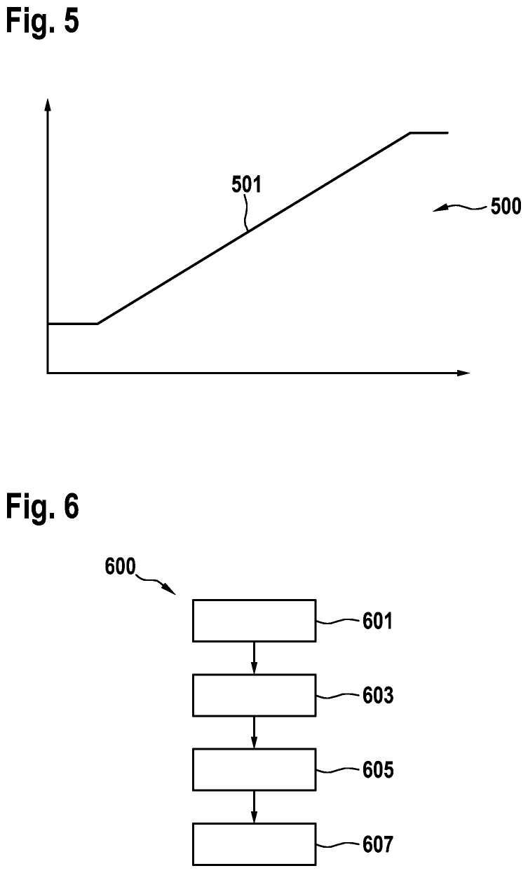

FIG. 5 shows a graph 500 extending along its abscissa along a path on the bipolar plate 100 and on the ordinates over a coolant temperature. A path 501 shows that there is a linear relationship between a travel path on the bipolar plate and a heating of the coolant. Accordingly, no particularly hot or cold spots are formed on the bipolar plate 100, such that the bipolar plate 100 is uniformly tempered and shows correspondingly little aging potential.

FIG. 6 shows a manufacturing method 600. The production method 600 comprises, for a top shell and a bottom shell, an extrusion step 601 for extruding a material comprising plastic, a first generation step 603 for generating a first pattern of flow channels on a first side of the material, and a second generation step 605 for generating a second pattern of flow channels on a second side of the material opposite to the first side, whereby the first pattern and the second pattern are generated independently of each other. Furthermore, the production method 600 comprises a connection step 607 for connecting the top shell to the bottom shell.

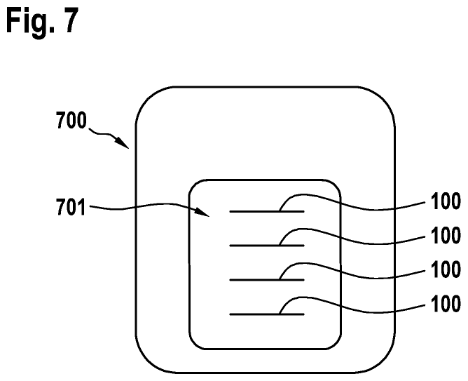

FIG. 7 shows a fuel cell system 700. The fuel cell system 700 comprises a fuel cell stack 701 having a plurality of bipolar plates 100.

1. A bipolar plate (100) for a fuel cell system (700),
wherein the bipolar plate (100) made of a material comprising plastic,
wherein the bipolar plate (100) comprises a top shell (200) and a bottom shell (300) with respectively a top side and a bottom side that is opposite the top side,
wherein flow channels (200) for guiding a first operating medium through the bipolar plate (100) are formed on the top side of the top shell,
wherein flow channels (205) for guiding a second operating medium through the bipolar plate (100) are formed between the bottom side of the top shell (200) and the top side of the bottom shell (300), wherein flow channels (307) for guiding a third operating medium through the bipolar plate (100) are formed on the bottom side of the bottom shell (300),
wherein the flow channels for guiding the first operating medium connect first inlet channels (105) and first outlet channels (111) for the first operating medium in a straight line,
wherein the flow channels (205) for guiding the second operating medium extend in a straight line between second inlet channels (107) and second outlet channels (113) for the second operating medium, wherein the second inlet channels (107) and the second outlet channels (113) for the second operating medium extend orthogonally to the flow channels (205) in order to guide the second operating medium, and
wherein the flow channels (307) for guiding the third operating medium extend in a straight line between third inlet channels (109) and third outlet channels (115) for the third operating medium, wherein the third inlet channels (109) and the third outlet channels (115) for the third operating medium extend orthogonally to the flow channels (307) for guiding the third operating medium.

2. The bipolar plate (100) according to claim 1, characterized in that
a connection line between the second inlet channels (107) and the second outlet channels (113) intersects with a connection line between the third inlet channels (109) and the third outlet channels (115).

3. The bipolar plate (100) according to claim 1, characterized in that
the plastic is an electrically and thermally conductive thermoplastic.

4. The bipolar plate (100) according to claim 1, characterized in that
flow channels of the top shell (200) and the bottom shell (300) formed on their respective top sides differ at least in regions in their cross-section, and/or their orientation, and/or the number of flow channels formed on their respective bottom sides.

5. The bipolar plate (100) according to claim 1, characterized in that
flow channels of the top shell (200) and the bottom shell (300) formed on the top side are formed mirror-symmetrically, at least in regions, with respect to a mirror axis extending between the top shell (200) and the bottom shell (300).

6. A production method (600) for a bipolar plate (100) according to claim 1,
wherein the production method (600) for the top shell (200) and the bottom shell (300) in each case comprises:
extruding (601) a material comprising plastic,
generating (603) a first pattern of flow channels on a first side of the material,
generating (605) a second pattern of flow channels on a second side of the material opposite to the first side, wherein the first pattern and the second pattern are generated independently of each other, and
connecting (607) the top shell (200) to the bottom shell (300) in order to produce the bipolar plate (100).

7. The production method (600) according to claim 6, characterized in that
the first pattern is generated using a first embossing tool, and the second pattern is generated using a second embossing tool.

8. The production method (600) according to claim 6, characterized in that
the first pattern is generated at a first timepoint, and the second pattern is generated at a second timepoint different from the first timepoint.

9. The production method (600) according to claim 7, characterized in that
a plurality of stamps or a double rollers are used as embossing tools.

10. A fuel cell system (700) having a bipolar plate (100) according to claim 1.

11. A bipolar plate (100) for a fuel cell system (700),
wherein the bipolar plate (100) made of a material comprising plastic,
wherein the bipolar plate (100) comprises a top shell (200) and a bottom shell (300) with respectively a top side and a bottom side that is opposite the top side,
wherein flow channels (200) for guiding a first operating medium through the bipolar plate (100) are formed on the top side of the top shell,
wherein flow channels (205) for guiding a second operating medium through the bipolar plate (100) are formed between the bottom side of the top shell (200) and the top side of the bottom shell (300), wherein flow channels (307) for guiding a third operating medium through the bipolar plate (100) are formed on the bottom side of the bottom shell (300),
wherein the flow channels for guiding the first operating medium connect first inlet channels (105) and first outlet channels (111) for the first operating medium in a straight line,
wherein the flow channels (205) for guiding the second operating medium extend in a straight line between second inlet channels (107) and second outlet channels (113) for the second operating medium, wherein the second inlet channels (107) and the second outlet channels (113) for the second operating medium extend orthogonally to the flow channels (205) in order to guide the second operating medium, and
wherein the flow channels (307) for guiding the third operating medium extend in a straight line between third inlet channels (109) and third outlet channels (115) for the third operating medium, wherein the third inlet channels (109) and the third outlet channels (115) for the third operating medium extend orthogonally to the flow channels (307) for guiding the third operating medium.

12. The bipolar plate (100) according to claim 11, characterized in that
a connection line between the second inlet channels (107) and the second outlet channels (113) intersects with a connection line between the third inlet channels (109) and the third outlet channels (115).

13. The bipolar plate (100) according to claim 12, characterized in that
the plastic is an electrically and thermally conductive thermoplastic.

14. The bipolar plate (100) according to claim 13, characterized in that
flow channels of the top shell (200) and the bottom shell (300) formed on their respective top sides differ at least in regions in their cross-section, and/or their orientation, and/or the number of flow channels formed on their respective bottom sides.

15. The bipolar plate (100) according to claim 14, characterized in that
flow channels of the top shell (200) and the bottom shell (300) formed on the top side are formed mirror-symmetrically, at least in regions, with respect to a mirror axis extending between the top shell (200) and the bottom shell (300).

16. A production method (600) for a bipolar plate (100) according to claim 11,
wherein the production method (600) for the top shell (200) and the bottom shell (300) in each case comprises:
extruding (601) a material comprising plastic,
generating (603) a first pattern of flow channels on a first side of the material,
generating (605) a second pattern of flow channels on a second side of the material opposite to the first side, wherein the first pattern and the second pattern are generated independently of each other, and
connecting (607) the top shell (200) to the bottom shell (300) in order to produce the bipolar plate (100).

17. The production method (600) according to claim 16, characterized in that
the first pattern is generated using a first embossing tool, and the second pattern is generated using a second embossing tool.

18. The production method (600) according to claim 17, characterized in that
the first pattern is generated at a first timepoint, and the second pattern is generated at a second timepoint different from the first timepoint.

19. The production method (600) according to claim 18, characterized in that
a plurality of stamps or a double rollers are used as embossing tools.

20. A fuel cell system (700) having a bipolar plate (100) according to claim 11.
